(19) United States
(12) Patent Application Publication
(10) Pub. No.: US 2023/0212858 A1
(43) Pub. Date: Jul. 6, 2023

(54) RAMPS TO FACILITATE CROSSING THRESHOLDS OF SLIDING DOORS

(71) Applicant: Handi Products, Inc., Kenosha, WI (US)

(72) Inventors: Eva Javier, Kenosha, WI (US); Victor Martinez, Kenosha, WI (US); Matt Wright, Kenosha, WI (US)

(21) Appl. No.: 18/148,113

(22) Filed: Dec. 29, 2022

Related U.S. Application Data
(60) Provisional application No. 63/295,180, filed on Dec. 30, 2021.

(51) Int. Cl. E04F 11/00

(52) U.S. Cl. CPC E04F 11/002; E04F 2011/005; E06B 7/28

(57) ABSTRACT

Ramps to facilitate crossing thresholds of sliding doors are disclosed. An example apparatus includes a ramp to be positioned adjacent a threshold of a sliding door; a bridge plate; and a hinge to rotatable couple the bridge plate to the ramp. The bridge plate is to rotate between a stowed position and a deployed position. The bridge plate is to be positioned clear of a path of a panel of the sliding door when in the stowed position. The bridge plate is to extend across the threshold when in the deployed position.

### RELATED APPLICATION(S)

This patent claims the benefit of U.S. Provisional Patent Application No. 63/295,180, which was filed on Dec. 30, 2021. U.S. Provisional Patent Application No. 63/295,180 is hereby incorporated herein by reference in its entirety. Priority to U.S. Provisional Patent Application No. 63/295,180 is hereby claimed.

### FIELD OF THE DISCLOSURE

This disclosure relates generally to accessibility ramps and, more particularly, to ramps to facilitate crossing thresholds of sliding doors.

### BACKGROUND

Many sliding door systems include at least one segment or panel that is able to slide or translate along a track in a plane of the segment or panel. Many sliding doors include a second segment or panel that is offset relative to the sliding segment or panel such that the two panels overlap when the sliding door is opened. In many instances, the panels of a sliding door are located on exterior walls of buildings and include floor to ceiling panes of glass to visually join a family room, kitchen or basement with an outside deck, patio, or porch.

### BRIEF DESCRIPTION OF THE DRAWINGS

FIG. 1 is a front exterior view of an example threshold ramp assembly constructed in accordance with teachings disclosed herein.

FIG. 2 is a perspective view of the example threshold ramp assembly of FIG. 1 from an exterior of the building with an example bridge in a deployed position.

FIG. 3 is a perspective view of the example threshold ramp assembly similar to FIG. 2 but with the example bridge 108 raised to a stowed position.

FIG. 4 is a perspective view of the example threshold ramp assembly of FIG. 1 from an interior of the building with the example bridge in the stowed position.

FIGS. 5-8 illustrate relevant measurements used to determine the size of the components of the example ramp assembly of FIGS. 1-4.

FIGS. 9-12 illustrate stages in an example method for installing the example ramp assembly of FIGS. 1-4.

FIG. 13 is an isometric exploded view of the example back support brace of the exterior ramp and the hinge of the ramp assembly of FIGS. 1-4.

FIG. 14 illustrates an exploded view of another example threshold ramp assembly constructed in accordance with teachings disclosed herein.

FIG. 15 illustrates an exploded view of another example threshold ramp assembly constructed in accordance with teachings disclosed herein.

In general, the same reference numbers will be used throughout the drawing(s) and accompanying written description to refer to the same or like parts. The figures are not necessarily to scale.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

### DETAILED DESCRIPTION

While aesthetically pleasing in design, sliding glass doors can present an obstacle for individuals who use wheelchairs, walkers, scooters, or other mobility devices. In particular, a common characteristic of most standard sliding glass door features is a raised u-channel that holds the movable portion of the door horizontally in place as it slides open and closed. Even though they are not greatly elevated in height, the tracks of sliding doors impede the wheels of mobility devices, and those same tracks can be damaged by scooters or wheelchairs. While the u-channel is needed to hold the door panel in place as it moves, the channel also can create a slip, trip, and fall hazard for people walking through the doorway. To help reduce the trip and fall hazard of the sliding glass door frame, to reduce the risk of the u-channel becoming an accessibility barrier to those in a wheelchair or scooter, and to comply with building codes, manufacturers often create a rounded or beveled threshold on both sides of the door.

According to accessibility guidelines of the Americans with Disabilities Act (ADA), sliding door thresholds should not exceed ¾ inches in height from an adjacent walking surface on either side for exterior sliding doors. However, these guidelines are applicable only for commercial and public properties. Similarly, the International Building Code (IBC), an important set of residential and commercial construction standards outside of the United States, recommends a maximum rise of ½ inches for tracks of sliding glass doors. Further, the Occupational Safety and Health Administration (OSHA) identifies any rise over ¼ inches as creating a trip hazard.

Despite the guidance for threshold heights, local building codes and inspectors are often relatively lax when it comes to drop-offs from a sliding door to an external porch or deck of private properties (e.g., single-family homes). It is not uncommon to find an outside deck that is several inches below the frame of a sliding glass door. The additional height on the outside of a sliding door is sometimes intentional to protect against snow accumulating above the threshold of the doorway, thereby risking melted snow (or wind driven rain) from flooding the inside of the building. However, this added height creates a trip and fall hazard and renders access through the doorway by wheelchairs, scooters, or other mobility devices difficult. Furthermore, in many instances where there is a relatively large drop-off from a sliding door threshold, the vertical distance between the threshold and walking surface on either side of the door is different, which can make transitions across the threshold (either by walking or with a wheelchair or scooter) awkward and/or difficult. To overcome these concerns, a ramp can be employed that has a height corresponding to the drop-off on the exterior of a sliding door to ease the transition between either side of the threshold of the door. In some examples, a ramp may additionally or alternatively be used on the inside if there is a significant height difference (e.g., above the recommended ¾ inches) between the interior walking surface and the top of the threshold.

While ramps can be placed on one or both sides of the threshold to ease a transition across the threshold, a wheelchair, scooter, or other mobility device still needs to cross the threshold. As mentioned above, the thresholds for sliding doors typically include a raised u-shaped track to support and guide the sliding door panel. Thus, ramps placed on either side of the threshold are necessarily spaced some distance apart such that there is not a continuous platform across which a wheeled mobility device can traverse. Examples disclosed herein provide a smooth, continuous platform over the tracks through the inclusion of a bridge or middle platform that extends across the threshold between ramps on either side of the threshold. In some examples, the bridge or middle platform is attached to and supported by the ramps on either side at a height that is above the top surface of the u-channel of the threshold, thereby protecting the u-channel from damage. Further, in some examples, the bridge or middle platform is rotatably attached (e.g., with a hinge) to one of the ramps so that the bridge can be rotated into position when needed and rotated out of the way when the door is to be closed. Thus, there is no need for the ramp system to be assembled and/or moved into position each time it is to be used and then disassembled and/or removed when not in use. That is, the entire assembly of some disclosed examples can remain positioned in place at the threshold while the sliding door is opened and closed. In some examples, the bridge or middle platform includes a tab or other protrusion that can be latched onto by an elongate hook or other tool to enable a user to move the bridge between a stowed position (e.g., out of the way of the sliding door) and an in-use or deployed position (e.g., spanning the threshold of the door). In some examples, the two ramps and interconnecting bridge are made of aluminum and have a weight capacity of at least 750 pounds. In some examples, the ramps and bridge include non-slip features (e.g., raised bumps) to increase traction.

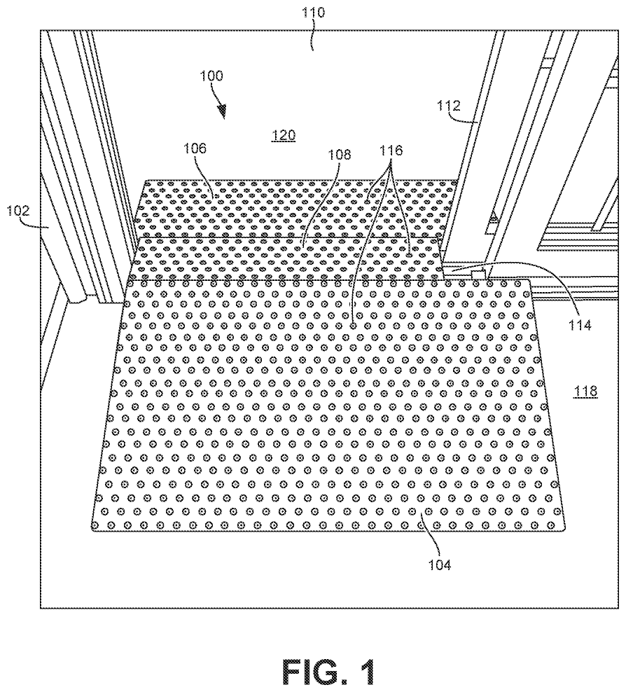

FIG. 1 is a front view of an example threshold ramp assembly 100 from an exterior of a building 102. The example threshold ramp assembly 100 includes a first ramp (e.g., exterior ramp) 104, a second ramp (e.g., interior ramp) 106, and an example bridge plate 108. As shown in FIG. 1, the first ramp 104 is positioned on an exterior (e.g., outdoor) side of the building in front of an opening 110 for a doorway that can be selectively blocked or unblocked by the closing or opening of a sliding door 112. The second ramp 106 is positioned on an interior (e.g., indoor) side of the building 102 adjacent the opening 110 opposite the first ramp 106. In the illustrated example, the sliding door 112 is open with the bridge plate 108 (also referred to herein as a crossover bridge or simply as a bridge for short) in a deployed position (also referred to herein as the in-use position). In the deployed position, the bridge 108 spans the threshold of the open sliding door 112 and the associated gap between the exterior ramp 104 and the interior ramp 106. Thus, the example threshold ramp assembly 100 provides a continuous platform extending across the threshold of the doorway and over a track 114 used to guide the sliding panel of the sliding door 112. The bridge 108 is an example means for providing a platform that extends across the threshold of a doorway. In some examples, one or more of the exterior ramp 104, the interior ramp 106, and the bridge 108 include non-slip features 116 (e.g., raised bumps, ridges, indentations, etc.) to improve traction when traversing the ramp assembly 100.

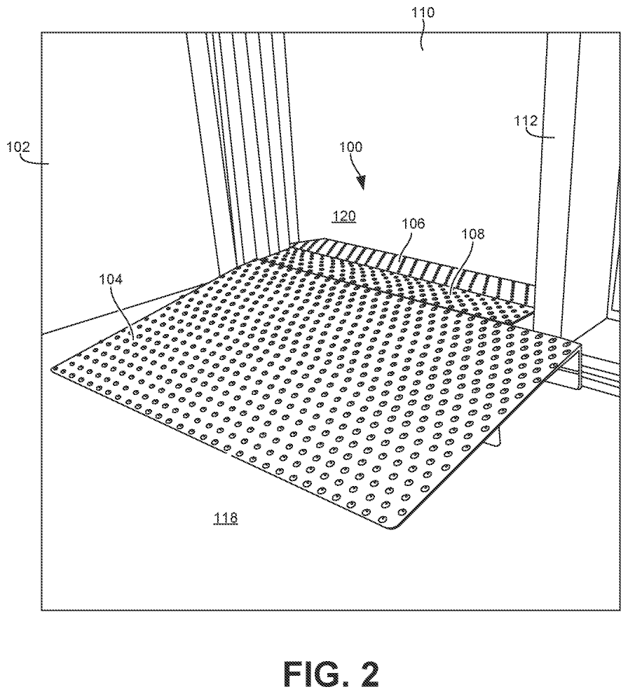

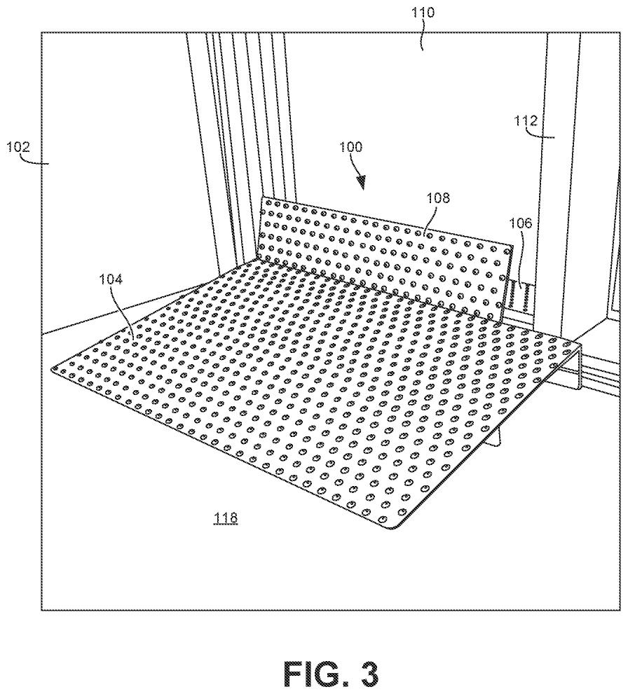

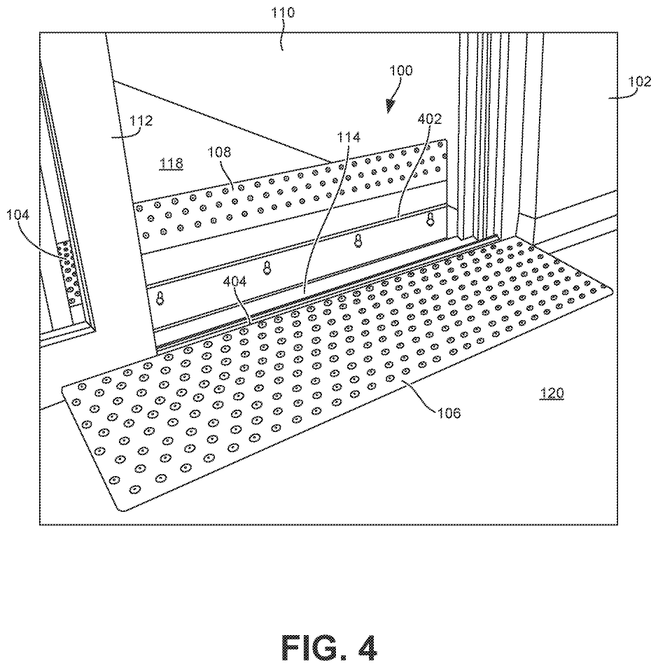

FIG. 2 is a perspective view of the example threshold ramp assembly 100 of FIG. 1 from an exterior of the building 102 with the bridge 108 in the deployed position similar to FIG. 1. FIG. 3 is a perspective view of the example threshold ramp assembly 100 similar to FIG. 2 but with the bridge 108 raised to a stowed position (also referred to herein as the stored position). In the stowed position, the bridge 108 extends upward and out of the way or clear of the path of the sliding panel of the sliding door 112 (e.g., the area directly above the track 114). In this manner, it is possible to fully close the door 112 without having to remove the ramp assembly 100. In some examples, the bridge 108 and an associated hinge 402 (shown in FIG. 4) are constructed to enable the bridge 108 to flip over and flatly rest on the associated ramp (e.g., the first ramp 104) when in the stowed position. FIG. 4 is a perspective view of the example threshold ramp assembly 100 of FIG. 1 from an interior of the building 102 with the bridge 108 in the stowed position. As shown in FIGS. 3 and 4, the bridge 108 rests in an upright position when in the stowed position. In other examples, the bridge 108 flips back on the exterior ramp 104 to which it is attached to rest flat on (e.g., substantially parallel to) the exterior ramp 104. In other examples, the bridge 108 can rest at any suitable angle relative to the exterior ramp 104.

In some examples, the exterior ramp 104 measures 30 inches wide. However, the exterior ramp 104 can be any suitable width. The height or rise of the exterior ramp 104 can be any suitable height and is selected based on the distance between an exterior walking surface 118 (supporting the exterior ramp 104) and the top of the threshold of the sliding door 112. More particularly, in some examples, the height or rise of the exterior ramp 104 is selected to be higher than the top of the threshold, including the height of the track 114 of the sliding door 112. The length of the exterior ramp can be any suitable length with longer lengths associated with taller ramps to provide a gentle, usable slope.

In some examples, the interior ramp 106 measures 30 inches wide. However, the interior ramp 106 can be any suitable width. The height or rise of the interior ramp 106 can be any suitable height and is selected based on the distance between an interior walking surface 120 (supporting the interior ramp 106) and the top of the threshold of the sliding door 112. More particularly, in some examples, the height or rise of the interior ramp 106 is selected to be higher than the top of the threshold, including the height of the track 114 of the sliding door 112. The length of the interior ramp can be any suitable length with longer lengths associated with taller ramps to provide a gentle, usable slope. In some examples, when the distance between the indoor walking surface and the top of the track for the sliding door is relatively small, the interior ramp 104 may be omitted.

As shown in FIGS. 4, the bridge 108 is rotatably coupled to the exterior ramp 104 with a hinge 402. In some examples, then the bridge 108 is rotated down into the deployed position, the bridge extends across the threshold and rests on a lip or edge 404 of the interior ramp 106. Thus, the hinge 402 is an example means for moving the bridge 1506 between a first (deployed) position and a second (stowed) position. With a first edge of the bridge 108 attached to the exterior ramp (via the hinge 402) and the opposite (distal) edge resting on the lip 404 of the interior ramp, the bridge is kept spaced apart from the underlying track 114 over which the bridge 108 crosses. As a result, the weight of the bridge 108 and any weight applied to the bridge 108 (e.g., the weight of a mobility device and/or a person crossing the bridge 108) is transferred to the ramps 104, 106, thereby protecting the underlying track 114 from damage. The width of the bridge 108 can be any suitable width and is selected to fit through the opening 110 of the doorway so as to crossover the threshold. The length of the bridge (e.g., from the pivot axis of the hinge 402 to the distal edge of the bridge) can be any suitable length and is selected based on the distance between the exterior and interior ramps 104, 106. While the bridge 108 is shown and described as being attached to the exterior ramp 104, in other examples, the bridge 108 can be connected to the interior ramp 106 and rests on the lip or edge of the exterior ramp 104 when in the deployed position.

In some examples, where the interior ramp 106 is omitted, the bridge 108 may include one or more protrusions on the underside of the bridge 108 near the distal edge away from the hinge 402. Such protrusion(s) can engage with the interior walking surface 120 when the bridge 108 is in the deployed position so as to keep the bridge off of the track 114 of the sliding door 112. In some examples, the interior ramp 106 is rigidly affixed to or integrated with the bridge 108 such that both the bridge 108 and interior ramp 106 are rotated about the hinge 402 and positioned outside the building 102 when in the stowed position and both flip down and pass through the opening 110 in the doorway when moved to the deployed position. In such examples, the widths of both the bridge 18 and the interior ramp 106 are selected to fit through the opening 110 in the doorway.

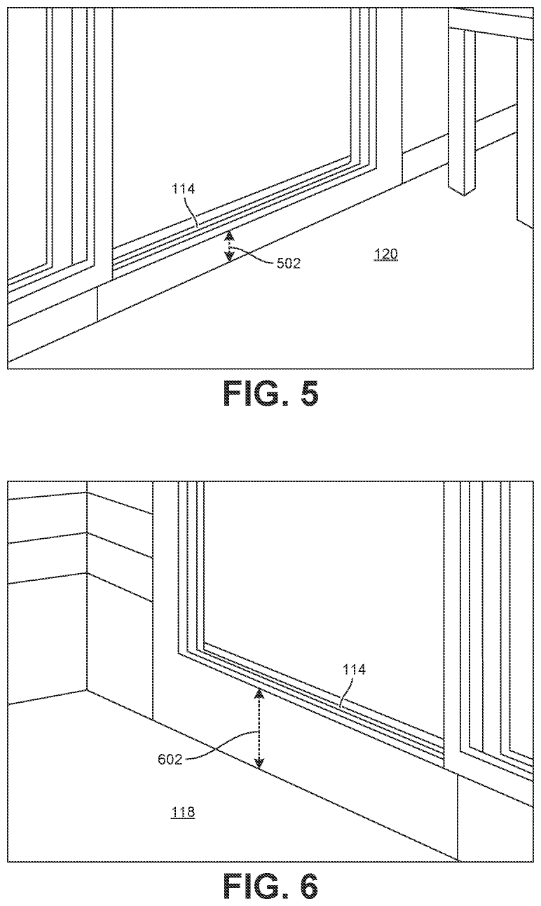

As described above, each of the ramps 104, 106 and the bridge 108 can have different sizes depending on the dimensions of the sliding door 112 where the ramp assembly 100 is to be implemented. FIGS. 5-8 illustrate relevant measurements used to determine the size of the ramp assembly components. Specifically, FIG. 5 identifies a first relevant measurement 502 corresponding to the distance from the interior floor (e.g., the interior walking surface 120) to the top of the interior threshold, including the sliding door tracks 114. This first measurement 502 determines the height or rise of the interior ramp 106. More particularly, this first measurement 502 defines the minimum height or rise of the interior ramp 106. In some examples, the height or rise of the interior ramp 106 is selected to be at least somewhat greater than the first measurement 502 to provide a gap or clearance between the tracks 114 and the underside of the bridge 108.

FIG. 6 identifies a second relevant measurement 602 corresponding to the distance from the exterior ground (e.g., the interior walking surface 118) to the top of the exterior threshold, including the sliding door tracks 114. This second measurement 602 determines the height or rise of the exterior ramp 104. More particularly, this second measurement 602 defines the minimum height or rise of the interior ramp 106. In some examples, the height or rise of the interior ramp 106 is selected to be at least somewhat greater than the second measurement 602 to provide a gap or clearance between the tracks 114 and the underside of the bridge 108. For many doors, the first measurement 502 (interior threshold height) is different than the second measurement 602 (exterior threshold height).

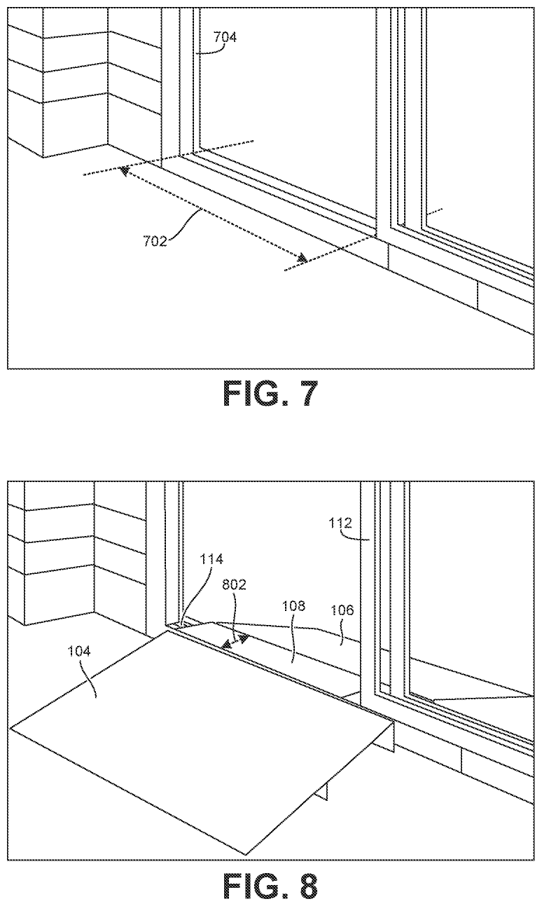

FIG. 7 identifies a third relevant measurement 702 corresponding to how wide the sliding door opens away from the door jamb 704. This third measurement 702 determines how wide the crossover bridge 108 can be (e.g., the maximum width for the bridge 108). In some examples, the width of the bridge 108 is selected to be somewhat less than the third measurement 702 to ensure free movement of the bridge 108 between stored and stowed positions.

FIG. 8 identifies a fourth relevant measurement 802 corresponding to the distance of the gap between the proximate edges of the exterior and interior ramps 104, 106, closest to the sliding door 112 threshold when in position for use to cross over the tracks 1104 of the sliding door 112. This fourth measurement 802 determines the length of the bridge 108.

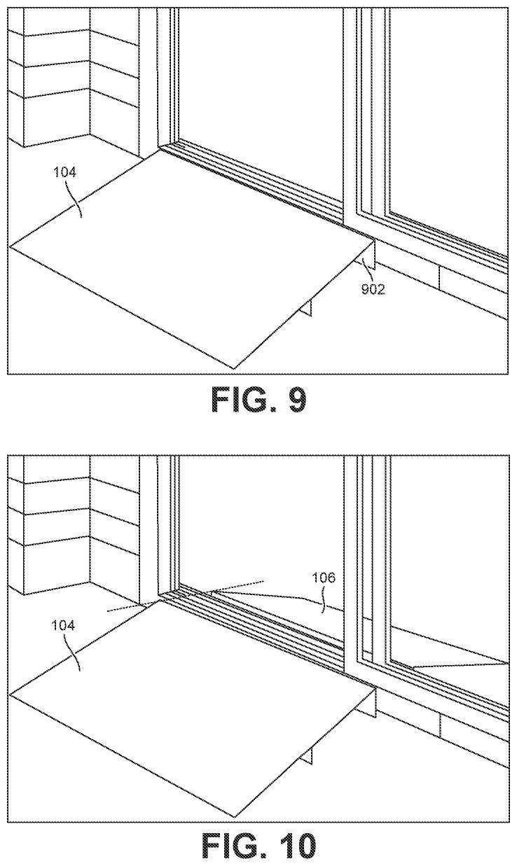

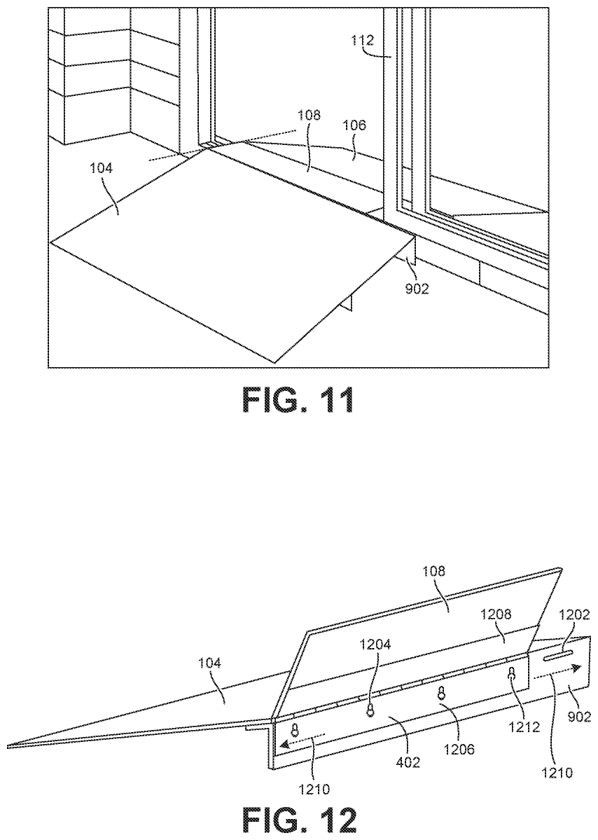

FIGS. 9-12 illustrate stages in an example method for installing the example ramp assembly 100 of FIGS. 1-4. As shown in FIG. 9, the exterior ramp 104 is aligned flush against the door threshold (e.g., a back plate or brace 902 of the exterior ramp 104 is positioned to be adjacent and/or abut against the door threshold). As shown in FIG. 10, the interior ramp 106 is aligned flush against the door threshold on the opposite side to the exterior ramp (e.g., a back plate or brace of the interior ramp 106 is positioned to be adjacent and/or abut against the door threshold). As shown in FIG. 11, the bridge 108 is aligned flush with the exterior and interior ramps 104, 106.

In some examples, the position of the bridge 108 relative to the exterior ramp 104 to which it is attached may be adjustable. More particularly, as shown in FIG. 12, in some examples, the exterior ramp 104 includes first holes or openings 1202 in its back support brace 902 that is to face the threshold of the sliding door 112. The first openings 1202 are to align with corresponding second holes or openings 1204 in a first (bottom) plate 1206 of the hinge 402 to enable attachment of the hinge 402 to the exterior ramp 104. In some examples, the openings 1202, 1204 in at least one of the exterior ramp 104 (e.g., the support brace 902 of the ramp 104) or the hinge 402 (e.g., the bottom plate 1206 of the hinge 402) are elongate slots so that the bridge 108 (attached to a second (upper) plate 1208 of the hinge 402) can be shifted relative to the exterior ramp 104 into a suitable position for the particular application in which the ramp assembly is to be used. More particularly, in some examples, the elongate slots are oriented to be substantially parallel to an axis of rotation of the hinge 402. In this manner, the bridge 108 can be shifted laterally relative to the exterior ramp 104 as represented by the arrows 1210 in FIG. 12. Once the position of the bridge 108 relative to the exterior ramp 104 is set, the bridge 108 is secured in place by fasteners 1212 (e.g., threaded fasteners, bolts, washers, etc.) through the aligned openings 1202, 1204. In some examples, other means for coupling the hinge 402 (and the associated bridge 108) to the exterior ramp 104 can be used (e.g., welding). The bridge 108 is coupled to the upper plate 1208 of the hinge 402 using any suitable means (e.g., threaded fasteners, welding, etc.).

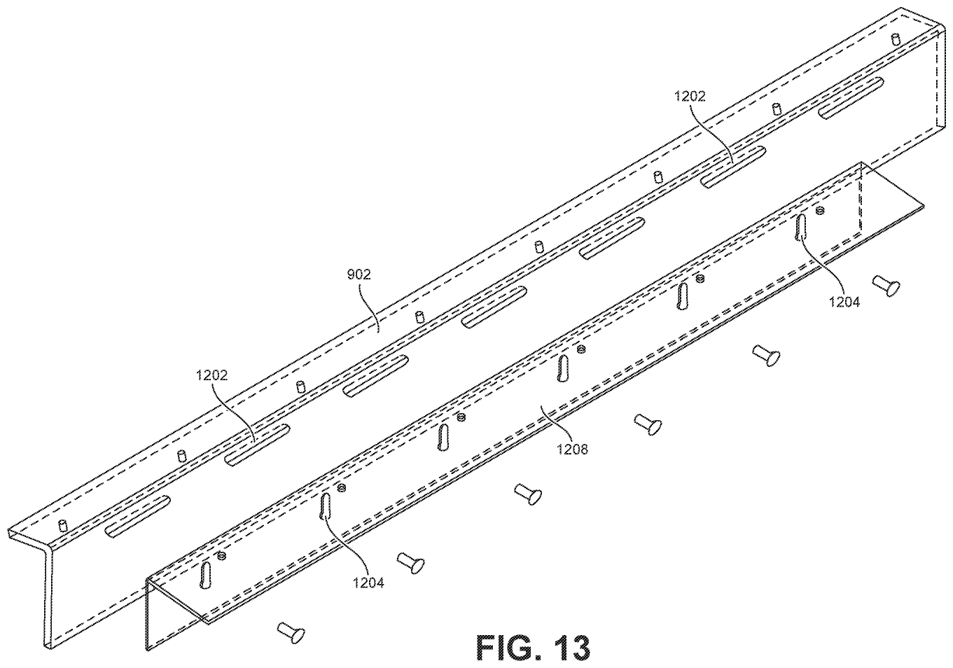

FIG. 13 is an isometric exploded view of the back support brace 902 of the exterior ramp 108 and the hinge 402. As shown in FIG. 13, in some examples, the number of the first openings 1202 on the support brace 902 is different than the number of the corresponding second openings 1204 on the hinge 402. As a result, different ones of the first openings 1202 can align with different ones of the second openings 1204 depending on the relative position of the hinge 402 (and associated bridge 108) and the exterior ramp 104. In the illustrated example, the number of first openings 1202 is greater than the number of the second openings 1204. In other examples, the number of first openings 1202 is less than the number of the second openings 1204. In some examples, at least one of the support brace 902 or the hinge 402 include a large number of openings 1202, 1204 positioned relatively close together to define increments by which the hinge 402 and ramp 104 can be shifted relative to one another without either of the openings being elongate slots.

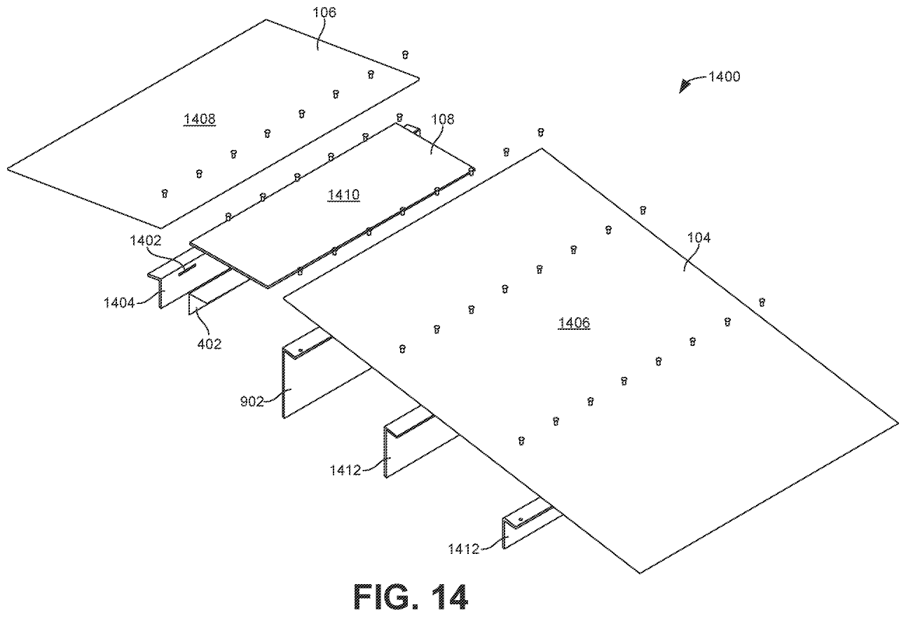

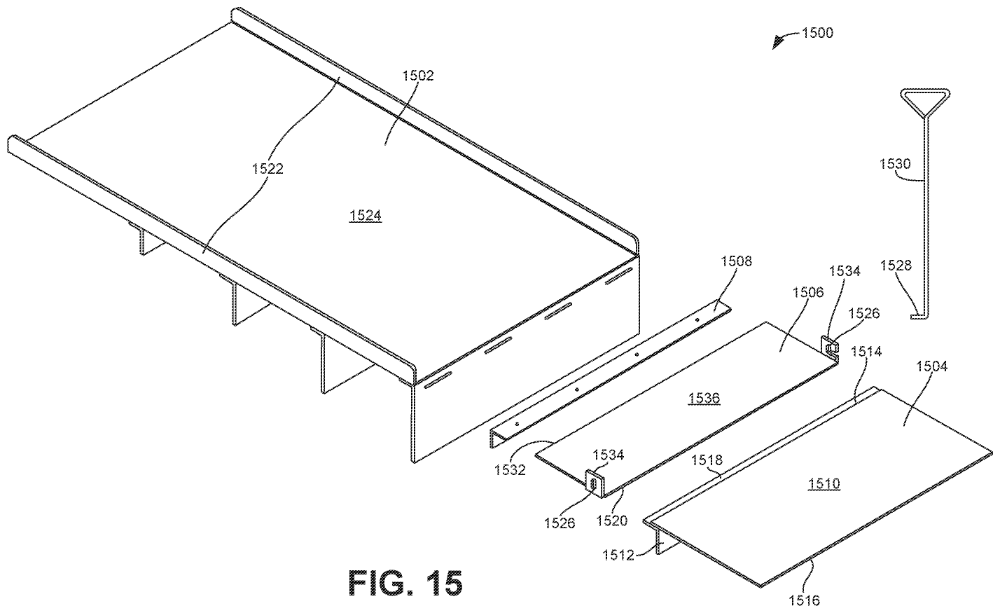

FIG. 14 illustrates an exploded view of another example ramp assembly 1400 constructed in accordance with teachings disclosed herein. In this example, the bridge 108 is to be attached to the interior ramp 106 as indicated by the holes or openings 1402 in the back plate or support brace 1404 of the interior ramp 106 that enable attachment of the bridge 108 via the hinge 402. As shown in the illustrated example, each of the ramps 104, 106 and the bridge 108 are made from respective sheets of metal 1406, 1408, 1410 that define the ramp surface or platform for the ramp assembly 1400. Further, each of the ramps 104, include corresponding back plates or support braces 902, 1404. In some examples, the support braces are L-shaped and coupled to the corresponding sheets of metal 1406, 1408 via threaded fasteners. In other examples, the sheets of metal 1406, 1408 can be coupled to the L-shaped braces 902, 1404 using any other means (e.g., welding). In some examples, in addition to the back support braces 902, 1404, the ramps 104, 106 include one or more intermediate support braces positioned between front (e.g., bottom) and rear (e.g., top) edges of the ramps 104, 106. Specifically, in the illustrated example, the exterior ramp 104 (the larger ramp in FIG. 14) includes two intermediate support braces 1412. However, any suitable number (e.g., 0, 1, 2, 3, 4, etc.) of intermediate braces can be implemented on either of the ramps 104, 106. As shown in the illustrated example, the back support braces 902, 904 and the intermediate braces 1406 are separate components that are attached to the ramp surfaces (e.g., the metal sheets 1406, 1408) via threaded fasteners. In other examples, the support braces 902, 1404, 1412 may be rigidly affixed to the ramp surfaces (e.g., via welding). In other examples, one or more of the support braces 902, 1404, 1412 may be integrally formed with the corresponding ramp surface.

FIG. 15 illustrates an exploded view of another example ramp assembly 1500 constructed in accordance with teachings disclosed herein. The example ramp assembly 1500 includes a first (e.g., exterior) ramp 1502, a second (e.g., interior) ramp 1504, and a bridge 1506 to extend between and be supported by the exterior and interior ramps 1502, 1504. Thus, the bridge 1506 is an example means for providing a platform that extends across the threshold of a doorway. In this example, the bridge 1506 is rotatably coupled to the exterior ramp 1502 via a hinge 1508. Thus, the hinge 1508 is an example means for moving the bridge 1506 between a first (deployed) position and a second (stowed) position. Similar to the examples disclosed above, the interior ramp 1504 includes a sheet of metal 1510 and an L-shaped back plate or support brace 1512. However, unlike the previous examples, the support brace 1512 is oriented differently to extend beyond the upper (e.g., rear) edge 1514 of the sheet of metal 1510 in a direction away from the bottom (e.g., front) edge 1516 of the sheet of metal 1510. In this example, the protruding portion of the support brace 1512 provides a lip 1518 onto which the first edge 1520 (distal to the hinge 1508) of the bridge 1506 is to rest when in the deployed or in-use position. That is, rather than the bridge 1506 resting on the upper metal sheet 1510 of the interior ramp 1504, in the illustrated example, the bridge 1506 rests on the lip 1518 of the support brace 1512 to position the bridge 1506 to be flush with (e.g., at the same height as) the metal sheet 1510 of the interior ramp 1510.

As shown in the illustrated example of FIG. 15, the exterior ramp 1502 includes rails 1522 on the lateral sides of the sheet of metal 1524 defining the upper surface of the ramp 1502. The rails 1522 serve to reduce the likelihood of the wheels of a mobility device inadvertently falling of the lateral sides of the exterior ramp 1502. Additionally or alternatively, in some examples, the interior ramp 1504 includes rails similar to those shown on the exterior ramp 1502. In some examples, the rails 1522 are separate components attached the sheet of metal 1524 using any suitable means (e.g., via fasteners, welding, etc.). In other examples, the rails 1522 are integrally formed with the sheet of metal 1524 (e.g., flanges bent upwards relative to the main surface of the sheet of metal 1524.

The example ramp assembly 1500 of FIG. 15 includes one or more openings, hooks, or slots 1526 on the bridge 1505 that are accessible from above the bridge 1506 when the bridge 1506 is in the deployed position. The slots 1526 are to facilitate movement of the bridge 1506 from the deployed position to the stowed position. More particularly, in some examples, the slots 1526 are constructed and positioned to enable engagement by a hook 1528 on an elongate lifting tool 1530. The lifting tool 1530, in conjunction with the slots 1526, enables a person in a wheelchair (or other person that may have difficulty reaching the floor) to lift the bridge 1506 from a deployed position to a stored position as discussed above. In some examples, as shown, the slots 1526 are positioned closer to the first edge 1520 of the bridge 1506 than the slots 1526 are to a second edge 1532 proximate the hinge 1508. In some examples, the slots 1526 are located on tabs 1534 connected to and protruding upwards from the bridge 1506. In examples that include the tabs 1534, the tabs may be separate components attached to the bridge 1506 via fasteners, welding, and/or any other suitable means. In other examples, the tabs 1534 are integrally formed with the sheet of metal 1536 of the bridge 1506. Two tabs 1534 are shown with different types of slots 1526 for purposes of illustration. In some examples, the slots 1526 are the same in both tabs 1534. Further, in some examples, only one tab 1534 is included. In other examples, more than two tabs 1534 are provided. In other examples, no tabs 1534 are included. Rather, in some such examples, the slots 1526 are provided directly into the sheet of metal 1536 defining the main surface of the bridge 1506.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

The foregoing example ramp assemblies 100, 1400, 1500 teach or suggest different features. Although each example ramp assembly 100, 1400, 1500 disclosed above has certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

From the foregoing, it will be appreciated that example systems, methods, apparatus, and articles of manufacture have been disclosed that provide ramps that facilitate crossing thresholds of sliding doors. Specifically, example ramps include a crossover bridge that spans that gap between ramps on either side of the threshold of the door over top of a track along with a panel of a sliding door slides to provide a continuous platform across the threshold. Further, in examples disclosed herein, the bridge is rotatably coupled to one of the ramps to enable the door to be rotated clear of the track, thereby enabling the door to be closed without having to remove the ramps on either side of the threshold.

Further examples and combinations thereof include the following:

Example 1 includes an apparatus comprising a ramp to be positioned adjacent a threshold of a sliding door, a bridge plate, and a hinge to rotatable couple the bridge plate to the ramp, the bridge plate to rotate between a stowed position and a deployed position, the bridge plate to be positioned clear of a path of a panel of the sliding door when in the stowed position, the bridge plate to extend across the threshold when in the deployed position.

Example 2 includes the apparatus of example 1, wherein the ramp is a first ramp, and the apparatus further includes a second ramp to be positioned adjacent the threshold, the first and second ramps on opposite sides of the threshold, the bridge plate to rest on the second ramp when in the deployed position.

Example 3 includes the apparatus of example 2, wherein a first height of the first ramp is greater than a second height of the second ramp.

Example 4 includes the apparatus of any one of examples 2 or 3, wherein the first ramp is to be positioned on an exterior side of the sliding door and the second ramp is to be positioned on an interior side of the sliding door.

Example 5 includes the apparatus of any one of examples 2-4, wherein the second ramp is to be positioned on an exterior side of the sliding door and the first ramp is to be positioned on an interior side of the sliding door.

Example 6 includes the apparatus of any one of examples 1-5, wherein the ramp is dimensioned to keep the bridge plate spaced apart from and above a track associated with the sliding door when the bridge plate is in the deployed position.

Example 7 includes the apparatus of example 6, wherein the bridge plate extends over the track without any material connected to the bridge plate extending into the track.

Example 8 includes the apparatus of any one of examples 1-7, wherein the bridge plate includes at least one of a slot or a hook accessible from above the bridge plate when the bridge plate is in the deployed position, the at least one of the slot or the hook to facilitate movement of the bridge plate from the deployed position to the stowed position.

Example 9 includes the apparatus of example 8, wherein the bridge plate includes a first edge proximate the hinge and a second edge distal to the hinge, the at least one of the slot or the hook positioned closer to the second edge than the at least one of the slot or the hook is to the first edge.

Example 10 includes the apparatus of any one of examples 8 or 9, wherein the at least one of the slot or the hook is on a tab connected to the bridge plate, the tab to protrude upwards from the bridge plate when the bridge plate is in the deployed position.

Example 11 includes the apparatus of any one of examples 1-10, wherein the hinge is coupled to the ramp via threaded fasteners extending through first openings in the ramp and second openings in the hinge.

Example 12 includes the apparatus of example 11, wherein at least one of the first openings or the second openings are elongate slots to enable a position of the bridge plate to shift relative to the ramp.

Example 13 includes the apparatus of any one of examples 1-12, wherein the ramp includes a sheet of metal including a first edge and a second edge opposite the first edge, the first edge corresponding to a bottom of the ramp and the second edge corresponding to a top of the ramp, and an L-shaped brace, the L-shaped brace to be attached to the ramp along the second edge of the sheet of metal.

Example 14 includes the apparatus of example 13, wherein the hinge is to be coupled to the L-shaped brace.

Example 15 includes the apparatus of any one of examples 13 or 14, wherein the L-shaped brace is a first L-shaped brace, the ramp including a second L-shaped brace, the second L-shaped brace to be attached to the ramp between the first and second edges of the sheet of metal, the first L-shaped brace to be taller than the second L-shaped brace.

Example 16 includes the apparatus of any one of examples 1-15, wherein the ramp includes rails extending along lateral sides of the ramp.

Example 17 includes an apparatus comprising a first ramp, a second ramp, the first and second ramps to be positioned on opposites side of a sliding door, and a bridge to extend across a threshold of the sliding door, the bridge to be supported by the first and second ramps, the bridge to be selectively movable to a stored position away from a path of a panel of the sliding door without moving the first ramp and without moving the second ramp.

Example 18 includes the apparatus of example 17, wherein the bridge is coupled to the first ramp via a hinge, the bridge selectively movable to the stored position by rotating about an axis of the hinge.

Example 19 includes the apparatus of example 18, wherein the second ramp includes a ramp surface including a first edge and a second edge opposite the first edge, the first edge corresponding to a bottom of the second ramp and the second edge corresponding to a top of the second ramp, and an L-shaped back plate, the L-shaped back plate to be attached to the ramp surface along the second edge, the L-shaped back plate to define a lip extending beyond second edge in a direction away from the first edge, the bridge to rest on the lip when the bridge is extended across the threshold of the sliding door and supported by the first and second ramps.

Example 20 includes an apparatus comprising a ramp to be positioned adjacent a threshold of a sliding door, means for providing a platform that extends across the threshold, and means for moving the platform providing means between (i) a first position in which the platform providing means to cross the threshold and (ii) a second position in which the sliding door is capable of being closed.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
a ramp to be positioned adjacent a threshold of a sliding door;
a bridge plate; and
a hinge to rotatable couple the bridge plate to the ramp, the bridge plate to rotate between a stowed position and a deployed position, the bridge plate to be positioned clear of a path of a panel of the sliding door when in the stowed position, the bridge plate to extend across the threshold when in the deployed position.

2. The apparatus of claim 1, wherein the ramp is a first ramp, and the apparatus further includes a second ramp to be positioned adjacent the threshold, the first and second ramps on opposite sides of the threshold, the bridge plate to rest on the second ramp when in the deployed position.

3. The apparatus of claim 2, wherein a first height of the first ramp is greater than a second height of the second ramp.

4. The apparatus of claim 2, wherein the first ramp is to be positioned on an exterior side of the sliding door and the second ramp is to be positioned on an interior side of the sliding door.

5. The apparatus of claim 2, wherein the second ramp is to be positioned on an exterior side of the sliding door and the first ramp is to be positioned on an interior side of the sliding door.

6. The apparatus of claim 1, wherein the ramp is dimensioned to keep the bridge plate spaced apart from and above a track associated with the sliding door when the bridge plate is in the deployed position.

7. The apparatus of claim 6, wherein the bridge plate extends over the track without any material connected to the bridge plate extending into the track.

8. The apparatus of claim 1, wherein the bridge plate includes at least one of a slot or a hook accessible from above the bridge plate when the bridge plate is in the deployed position, the at least one of the slot or the hook to facilitate movement of the bridge plate from the deployed position to the stowed position.

9. The apparatus of claim 8, wherein the bridge plate includes a first edge proximate the hinge and a second edge distal to the hinge, the at least one of the slot or the hook positioned closer to the second edge than the at least one of the slot or the hook is to the first edge.

10. The apparatus of claim 8, wherein the at least one of the slot or the hook is on a tab connected to the bridge plate, the tab to protrude upwards from the bridge plate when the bridge plate is in the deployed position.

11. The apparatus of claim 1, wherein the hinge is coupled to the ramp via threaded fasteners extending through first openings in the ramp and second openings in the hinge.

12. The apparatus of claim 11, wherein at least one of the first openings or the second openings are elongate slots to enable a position of the bridge plate to shift relative to the ramp.

13. The apparatus of claim 1, wherein the ramp includes:
a sheet of metal including a first edge and a second edge opposite the first edge, the first edge corresponding to a bottom of the ramp and the second edge corresponding to a top of the ramp; and
an L-shaped brace, the L-shaped brace to be attached to the ramp along the second edge of the sheet of metal.

14. The apparatus of claim 13, wherein the hinge is to be coupled to the L-shaped brace.

15. The apparatus of claim 13, wherein the L-shaped brace is a first L-shaped brace, the ramp including a second L-shaped brace, the second L-shaped brace to be attached to the ramp between the first and second edges of the sheet of metal, the first L-shaped brace to be taller than the second L-shaped brace.

16. The apparatus of claim 1, wherein the ramp includes rails extending along lateral sides of the ramp.

17. An apparatus comprising:
a first ramp;
a second ramp, the first and second ramps to be positioned on opposites side of a sliding door; and
a bridge to extend across a threshold of the sliding door, the bridge to be supported by the first and second ramps, the bridge to be selectively movable to a stored position away from a path of a panel of the sliding door without moving the first ramp and without moving the second ramp.

18. The apparatus of claim 17, wherein the bridge is coupled to the first ramp via a hinge, the bridge selectively movable to the stored position by rotating about an axis of the hinge.

19. The apparatus of claim 18, wherein the second ramp includes:
a ramp surface including a first edge and a second edge opposite the first edge, the first edge corresponding to a bottom of the second ramp and the second edge corresponding to a top of the second ramp; and
an L-shaped back plate, the L-shaped back plate to be attached to the ramp surface along the second edge, the L-shaped back plate to define a lip extending beyond second edge in a direction away from the first edge, the bridge to rest on the lip when the bridge is extended across the threshold of the sliding door and supported by the first and second ramps.

20. An apparatus comprising:
a ramp to be positioned adjacent a threshold of a sliding door;
means for providing a platform that extends across the threshold; and
means for moving the platform providing means between (i) a first position in which the platform providing means to cross the threshold and (ii) a second position in which the sliding door is capable of being closed.
